(19) United States
(12) Patent Application Publication
(10) Pub. No.: US 2010/0091107 A1
(43) Pub. Date: Apr. 15, 2010

(54) HIGH SPEED OPTICAL MONITORING SYSTEM

(75) Inventors: Dong Youn SHIN, Daegu (KR); Kyung Hyun HWANG, Seoul (KR); Taik Min LEE, Daejeon (KR); Dong Soo KIM, Daejeon (KR)

Correspondence Address: HOLME ROBERTS & OWEN LLP, 1700 LINCOLN STREET, SUITE 4100, DENVER, CO, 80203, US

(73) Assignee: KOREA INSTITUTE OF MACHINERY & MATERIALS, Daejeon (KR)

(21) Appl. No.: 12/326,254

(22) Filed: Dec. 2, 2008

(30) Foreign Application Priority Data
Oct. 10, 2008 (KR) 10-2008-0099686

(51) Int. Cl. H04N 7/18

(52) U.S. Cl. 348/158; 348/E07.085

(57) ABSTRACT

The present invention discloses a high speed optical monitoring system being capable of monitoring clearly a subject at a high speed and having a small dimension. The high speed optical monitoring system for monitoring at least one subject which is in a stationary state or being moved, comprises at least one subject source for generating the subject; a subject source support for aligning and supporting the subject source so as to allow the subject to be placed on an identical focal space plane; an image acquisition means provided with an electrically-powered zoom lens capable of controlling a focal length between the image acquisition means and the subject, a magnification and a depth; a mirror body mounted between the subject and the image acquisition means; a mirror driving unit for changing a rotational angle of the mirror body; an image processing unit for processing an image acquired by the image acquisition means into digital data; a lighting means for illuminating the subject; and a control unit for controlling the lighting means and driving of the subject source, the image acquisition means and the mirror.

### CROSS-REFERENCE TO RELATED APPLICATION

This application claims priority from Korean Patent Application No. 10-2008-0099686, filed on Oct. 10, 2008, the contents of which are incorporated herein by reference in its entirety.

### FIELD OF THE INVENTION

The present invention relates to a high speed optical monitoring system.

### BACKGROUND OF THE INVENTION

A conventional subject monitoring apparatus for monitoring a plurality of subjects is disclosed in Korean Patent Application No. 10-2005-0092641 as shown in FIG. 1. The subject monitoring apparatus 101 is constructed such that a subject monitoring camera 120 is mounted on at least one moving stage 130 and moved in the X-direction and/or the Y-direction to monitor sequentially subjects 110 existing on an identical focal space plane F.

Alternatively, in a case where the subjects 110 to be monitored are generated in the identical subject source 111, the subject source 111 is moved together with a subject source support 112 by at least one moving stage 131 in the X-direction and/or the Y-direction, and so the camera 120 which is in a stationary state can sequentially and individually monitor the subjects 110.

Meanwhile, the camera 120 and the subjects 110 are arranged such that the subjects 110 can be sequentially monitored by the camera 120 while both the moving stage 130 for the camera 120 and the moving stage 131 for the subject source 111 and the subject source support 112 are mutually moved.

In the conventional subject monitoring apparatus as described above, however, since the subjects are monitored while the camera and/or the subjects are moved by the moving stages, the monitoring time is delayed by required time durations depending on the moving distances of the moving stages, resulting in a problem of difficulty in monitoring the subjects in a high speed manner.

In addition, due to a vibration generated during a movement of the moving stage, an image of the subject obtained by the camera is shaken. In particular, since the conventional subject monitoring apparatus is provided with the moving stage, a dimension of the apparatus is extremely large.

### SUMMARY OF THE INVENTION

Accordingly, an object of the present invention is to provide a high speed optical monitoring system being capable of monitoring clearly a subject at a high speed and having a small dimension.

In order to achieve the above object, the high speed optical monitoring system for monitoring at least one subject which is in a stationary state or being moved, comprises at least one subject source for generating the subject; a subject source support for aligning and supporting the subject source so as to allow the subject to be placed on an identical focal space plane; an image acquisition means provided with an electrically-powered zoom lens capable of controlling a focal length between the image acquisition means and the subject, a magnification and a depth; a mirror body mounted between the subject and the image acquisition means; a mirror driving unit for changing a rotational angle of the mirror body; an image processing unit for processing an image acquired by the image acquisition means into digital data; a lighting means for illuminating the subject; and a control unit for controlling the lighting means and driving of the subject source, the image acquisition means and the mirror.

The high speed optical monitoring system may further comprise a subject source alignment unit coupled to the subject source support so as to move linearly the subject source along the X/Y/Z axes and tilt the subject source with respect to each of the X/Y/Z axes.

Here, the image acquisition means is a camera having a CCD or CMOS imaging device provided with an electrically-powered device capable of adjusting a magnification, a focal length and a depth.

And, it is preferable that the lighting means utilizes a LED (light emitting diode) or a laser diode.

The high speed optical monitoring system may further comprise a light quantity variation compensation unit for compensating light quantity variation of the lighting means.

It is preferable that the lighting means comprises a cooling device for blocking heat generated from a light source thereof.

In addition, the high speed optical monitoring system of the present invention may further comprise an optical filter provided on the optical path between the subject and the image acquisition means, and the optical filter being at least one of an infrared blocking filter, a polarization filter, a color filter and a band-pass filter.

In particular, the high speed optical monitoring system according to the present invention may further comprises a reference sample arranged on the identical focal space plane so as to check and calibrate an optical alignment relations among the subject, the image acquisition means and the mirror body and a scale and a distortion of the acquired image.

The mirror driving unit constituting the present invention transmits an electrical detection signal for the rotational angle of the mirror body to the control unit, and the control unit receives the electrical detection signal for the rotation angle of the mirror body and controls driving of the mirror driving unit so as to control the rotational angle of the mirror body.

Also, the image processing unit uses the digital data to process temporal and spatial information including the size, trajectory, speed and location of the subject.

In the high speed optical monitoring system of the present invention, the control unit feedback-controls a generation of the subject of the subject source, an adjustment of the rotating angle of the mirror body, a driving of an imaging operation of the image acquisition means and the quantity of light, impulse time and impulse timing of the lighting means on the basis of the digital date.

In the meantime, the image acquisition means is placed at a side of the optical path between the subject and the mirror body.

Also, the mirror body has an inclined mirror surface and the image acquisition means is placed above and below the optical path between the subject and the mirror body. In addition, the mirror body has a plurality of inclined mirror surfaces and the image acquisition means is placed at a rear of the optical path between the subject and the mirror body.

### BRIEF DESCRIPTION OF THE DRAWINGS

The above and other features and advantages of the present invention will become readily apparent by reference to the following detailed description when considered in conjunction with the accompanying drawings wherein;

FIG. 1 is a schematic perspective view of a conventional optical monitoring apparatus;

FIG. 2 is a schematic view showing a structure of a high speed optical monitoring system according to the present invention;

FIG. 3 is a control block diagram of a high speed optical monitoring system according to the present invention; and

FIG. 4 to FIG. 10 are schematic views showing structures of high speed optical monitoring systems according to other embodiments of the present invention.

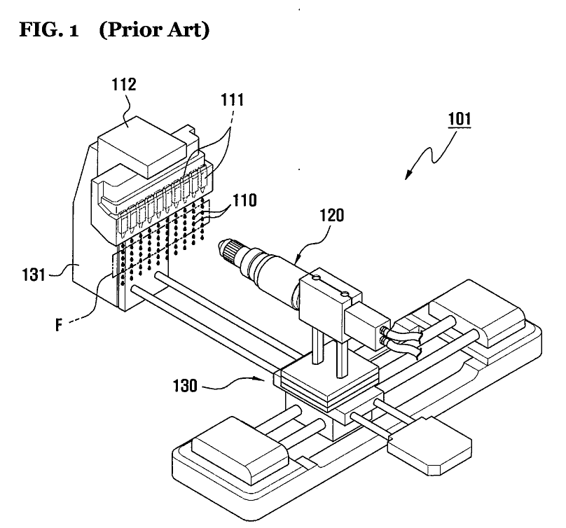

### DESCRIPTION OF SPECIFIC EMBODIMENTS

Hereinafter, the preferred embodiments of the present invention will be explained in more detail with reference to the accompanying drawings. However, it should be understood that the embodiment of the present invention can be variously modified, a scope of the present invention is not limited to the embodiment described herein, and the embodiment is provided for explaining more completely the present invention to those skilled in the art.

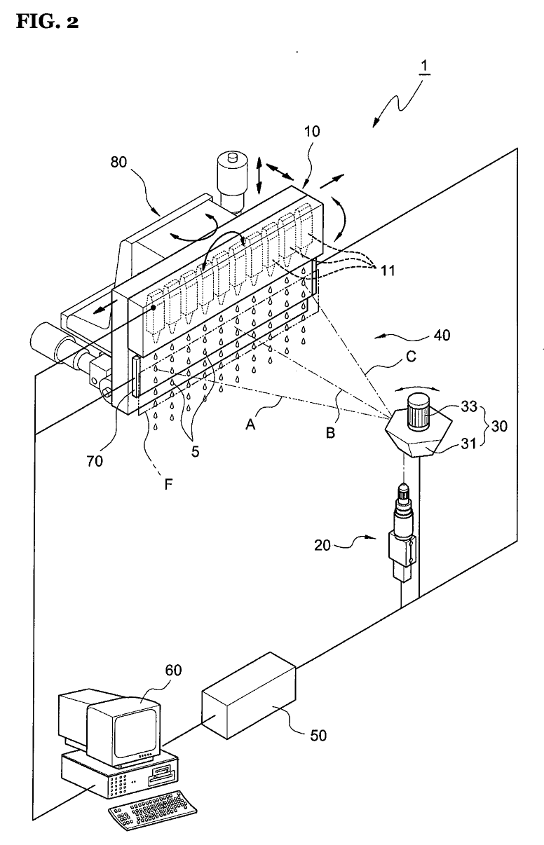

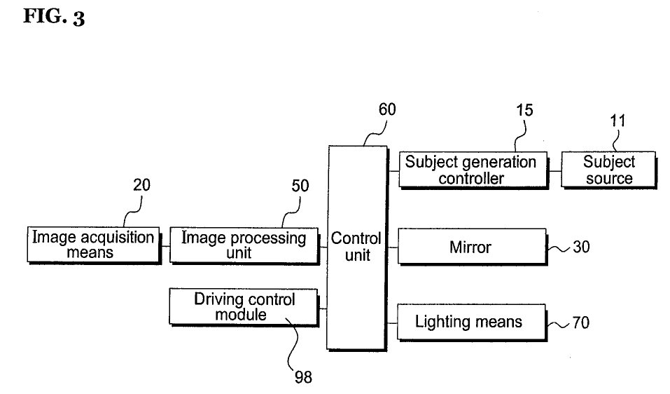

FIG. 2 is a schematic view showing a structure of a high speed optical monitoring system according to the present invention, and FIG. 3 is a control block diagram of a high speed optical monitoring system according to the present invention.

As shown in the drawings, a high speed optical monitoring system 1 according to the present invention comprises a subject source support 10 for supporting at least one subject source 11 which generates at least one subject 5; an image acquisition means 20 placed at a front of the subject source 11 for monitoring and imaging the subject 5; a mirror 30 disposed on an optical path between the subject 5 and the image acquisition means 20 for transmitting an image of the subject 5 to the image acquisition means 20; a lighting means 70 for imparting a certain quantity of light to the subject 5; an image processing unit 50 for processing an image acquired by the image acquisition means 20 into data; and a control unit 60 for controlling operations of the subject source 11, the image acquisition means 20, the mirror 30 and the lighting means 70.

The subject source support 10 can support the subject sources 11 in a line within a predetermined length range so as to enable the subjects 5 to be placed on an identical focal space plane F, and may comprise a subject source alignment unit 80 capable of making the subject source 11 move linearly along the X/Y/Z axes and making the subject source 11 rotate with respect to each of X/Y/Z axes, if necessary, and so the subjects 5 may be aligned finely locationed on the identical focal space plane F.

Here, the subjects 5 generated from each of the subject sources 11 may be stationary or moved on the identical focal space plane, or may be moved with their periodic time characteristics. If the subjects 5 to be monitored are liquid such as ink droplets, the subjects may be transparent, translucent or opaque. Further, the subjects 5 may cause light to be refracted, diffracted, reflected or scattered, and can be monitored preferably in a dark field or a bright field.

For example, if the subject source 11 is an inkjet head and the subjects 5 are ink particles discharged from the inkjet head, each of the subjects 5 may have a size of about 5 μm to 100 μm and a discharging ratio of about 1 m/s to 20 m/s. Further, the number of subjects 5 that should be monitored at a time may be varied from 1 to 200, and the subjects 5 may have a predetermined periodical movement characteristic.

The shape of the subject 5 as described above is only for illustrative purposes, and the size, the moving speed, the number and the periodic time characteristic of the subject and a generation source of the subject may be varied.

Further, the subject source alignment unit 80 is provided to move spatially or incline the subject source 11 to allow the subjects 5 to be placed on the identical focal space plane F recognized by the image acquisition means 20. As a result, the subject source alignment unit serves to align one or more subjects 5 generated from the subject source 11 on the identical focal space plane.

More specifically, the subject source alignment unit 80 allows a stage coupled to the subject source support 10 to be moved linearly along the X/Y/Z axes and rotated with respect to each of the X/Y/Z axes to enable the subject source 11 to be moved linearly along the X/Y/Z axes and rotated with respect to each of the X/Y/Z axes.

Here, the subject source alignment unit 80 may employ a conventional 6-axis manual stage scheme. As one example, a 6-axis manual stage scheme in which a cylindrical rod having threads formed thereon with certain pitch is rotated to drive the stage in the 6-axis directions may be used as the subject source alignment unit 80. It will be apparent that, as the subject source alignment unit 80, an automatic alignment unit comprising gears such as worm gears or bevel gears, a step motor and the like for driving the stage coupled to the subject source 11 in the 6-axis directions may be employed.

Moreover, the subject source alignment unit 80 may be driven by means of an automatic operation performed by manipulating a button or the like, by means of a pre-programmed software. In addition, the subject source alignment unit may be connected electrically to a vision recognition system for aligning the subjects through an automatic control of the control unit 60. At this time, the subject source alignment unit 80 may be provided to allow the respective subject source 11 to be moved independently in the 6-axis directions.

The above subject source alignment unit 80 is set up to enable the subjects 5 generated from the subject source 11 to be placed in the identical focal space plane F upon initial setting of the system, so that the subjects 5 can be finely imaged by the image acquisition means 20 in a state where the subject source support 10 and the image acquisition means 20 are aligned.

The image acquisition means 20 is provided to monitor and image the subjects 5 and acquire an image of the subjects 5, and a camera having a CCD (charge coupled device) or a CMOS (complementary metal oxide semiconductor) imaging device may be used as the image acquisition means 20. At a front of the subject source 11, the image acquisition means 20 is fixed vertically above or below the mirror 30 to monitor and image the subject 5 transmitted through the mirror 30.

Here, it is preferable to use a camera having an imaging device capable of acquiring a high-definition image with a relative high frame rate and a high resolution. Although not shown in detail in the drawing, in addition, in order to monitor the subject 5 at a high speed through a rotation of the mirror, it is preferable to utilizing a zoom lens being capable of adjust a magnification of the camera and a focal length between the camera and the subject. Moreover, it is preferable that the camera further comprises an aperture for adjusting the depth and the quantity of light.

It will be apparent that, besides the CCD camera or the CMOS camera, various kinds of image acquisition means may be used as the image acquisition means 20 so far as they can monitor and image the subject 5 and acquire the image of the subject 5.

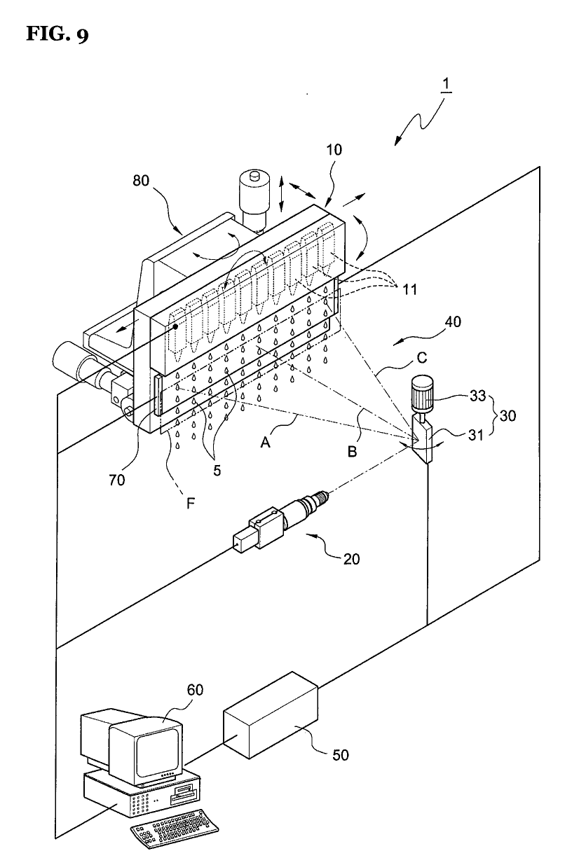

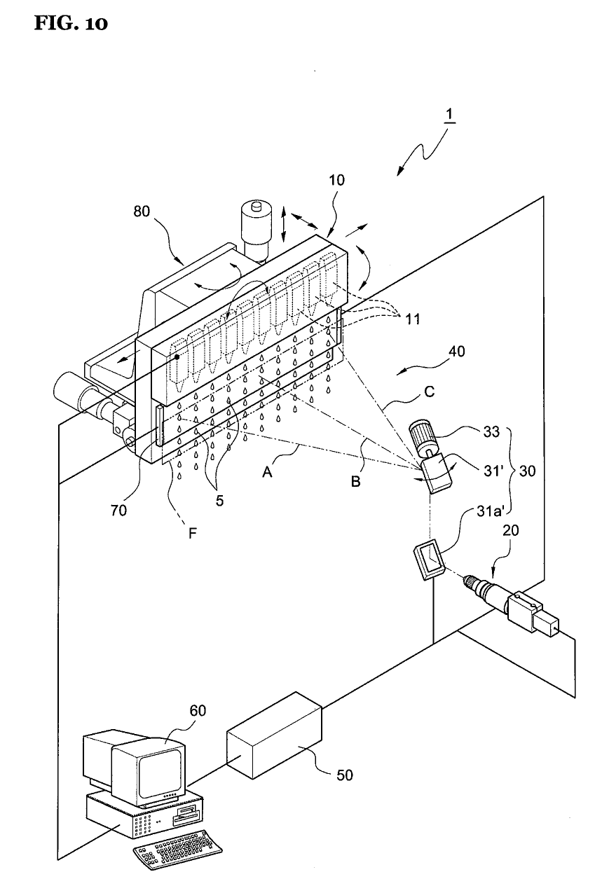

In the meantime, besides the structure in which the camera used as the image acquisition means 20 is fixed vertically above or below the mirror 30, the image acquisition means 20 may be provided at a side of the mirror 30 or at a lower area of a rear of the mirror 30 to monitor and image the subject 5 transmitted through the mirror 30 as shown in FIG. 9 and FIG. 10.

The mirror 30 comprises a mirror body 31 for changing an optical path between the subject 5 and the image acquisition means 20, and a mirror driving unit 33 for driving the mirror body 31.

As the mirror body 31, a polygon mirror having a plurality of mirror surfaces may be provided. Here, the mirror surface of the mirror body is inclined from a side corresponding to the subject 5 to the other side corresponding to the image acquisition means 20 so that the mirror surface is directed to the subject 5 and the image acquisition means 20 placed at a front of the subject 5.

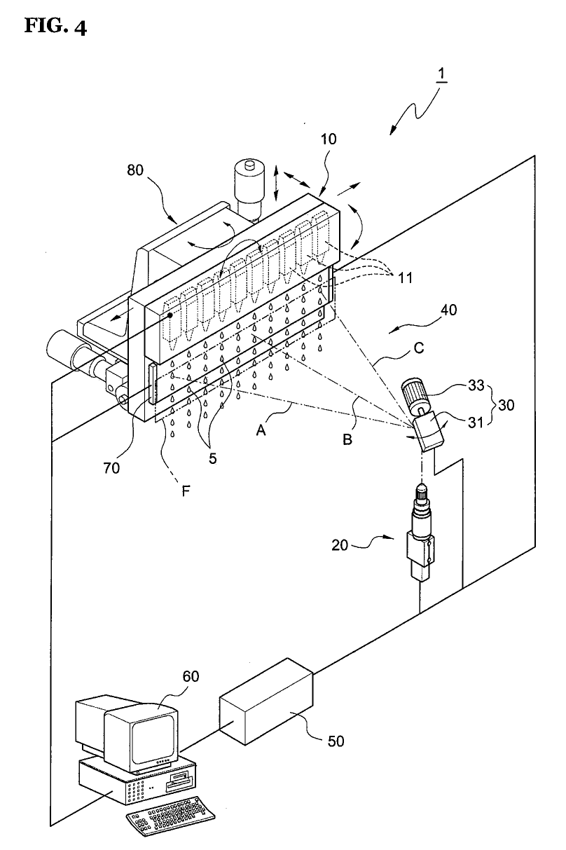

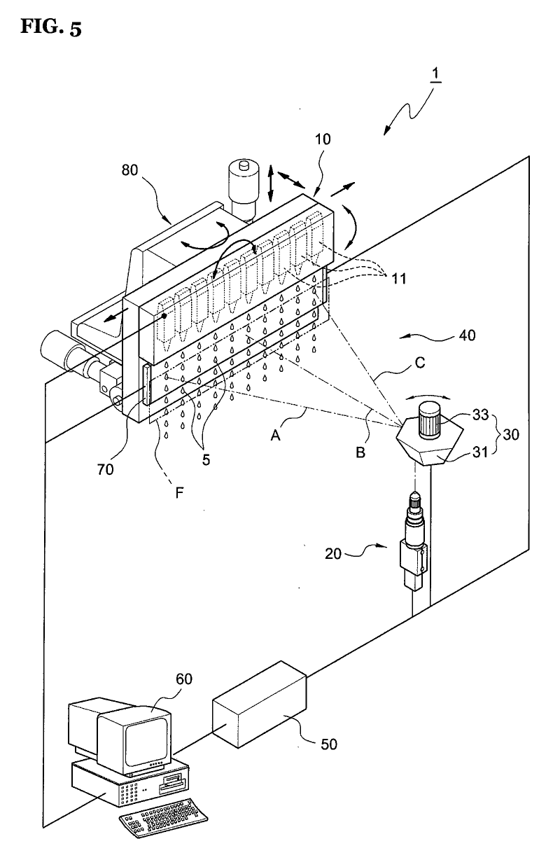

As the mirror body 31, as shown in FIG. 4, a planar mirror having a single mirror surface may be employed. At this time, the mirror surface is inclined upward or downward.

And, it is preferable that a reversible motor such as a step motor capable of adjusting finely the rotational angle of the mirror body 31 is employed as the mirror driving unit 33.

In such mirror 30, the driving of the mirror driving unit 33 changes the rotational angle of the mirror body 31 to refract the optical path directed from the subject 5 to the image acquisition means 20. Therefore, it is possible to acquire an image of the subject 5 to be monitored in a state where the image acquisition means 20 and the subject source 11 are aligned.

At this time, the mirror driving unit 33 transmits an electrical detection signal on the rotational angle of the mirror body 31 to the control unit 60, and so the control unit 60 may control the driving of the mirror driving unit 33 to optimize the rotational angle of the mirror body 31.

As shown in FIG. 10, in the meantime, the mirror 30 may consist of a first mirror body 31′ and a second mirror body 31a′. A rotational angel of the first mirror body can be adjusted by a driving of the mirror driving unit 33 to adjust an optical path according to a location of the camera acting as the image acquisition means 20, and the second mirror body 31a′ guides an optical path to the image acquisition means 20 with respect to the first mirror body 31′.

The lighting means 70 radiates a sufficient quantity of light to the subjects 5 to ensure brightness required for the imaging of the image acquisition means 20 such as the camera.

It is preferable that, as the lighting means 70, a lighting device such as an impulse-type LED (light emitting diode) or an impulse-type laser diode which are associated with the movement of the subject 5 is employed. Here, as the moving speed of the subject 5 becomes faster, a sufficient quantity of light and a shorter impulse are required to obtain a clear image.

Further, in order to provide a sufficient quantity of light within a limited frame rate of the image acquisition means 20, it is preferable to select a lighting means having higher instantaneous illuminance and a wavelength range with higher sensitivity to the imaging device of the image acquisition means 20 so far as the subject 5 is not affected by optical sensitivity. At this time, it is preferable that a wavelength range by which an optical reaction to the subject 5 is prevented is selected as a primary wavelength range of the lighting means 70.

The lighting means 70 may be provided integrally with the subject source support 10 to illuminate entirely the subjects 5 generated from the subject sources 11, or a lighting means (although not shown in the drawings) may be provided behind each of the subjects 5 generated from each of the subject sources 11 to illuminate independently the subjects 5 generated from the subject sources 11. Alternatively, although not shown in the drawings, the lighting means 70 may be provided such that the lighting means can be moved to the location at which the subject 5 corresponding to an image recognition area of the image acquisition means 20 can be illuminated by the lighting means.

Also, although not shown in the drawing, the lighting means 70 may be provided in the image acquisition means 20 to illuminate the subjects 5.

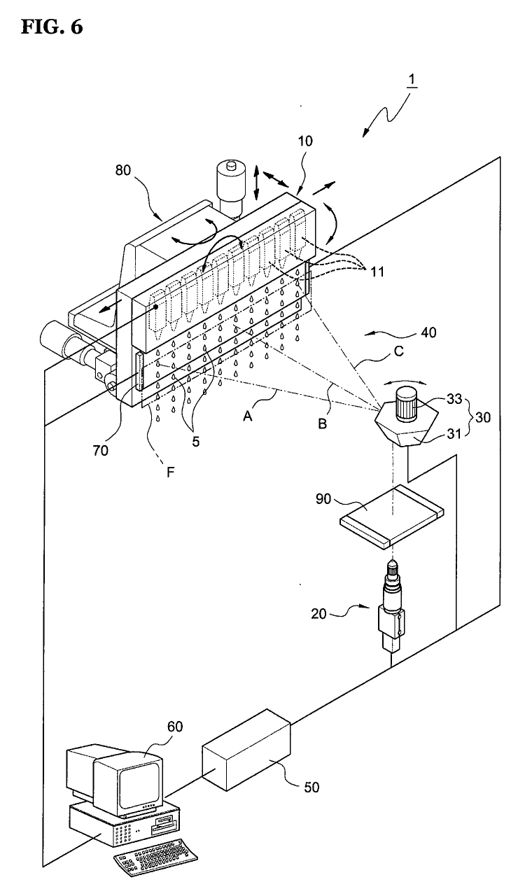

As shown in FIG. 6, in addition, in order to compensate variations in the quantity of light of the lighting means 70, a light quantity variation compensating unit 90 including at least one of a collimator, a homogenizer and a diffuser may be arranged on the optical path between the subject 5 and the image acquisition means 20.

In addition, the lighting means 70 may be provided separately at a location spaced from the subject 5 by a certain distance to illuminate indirectly the subject. Also, the lighting means 70 may comprises a cooling device for blocking a heat generated in the light source. Due to the cooling device, it is possible to prevent effectively a deformation of the subject 5 and the subject source 11 caused by heat generated from the lighting means.

Meanwhile, the image processing unit 50 digitalizes the image of the subject 5 acquired by the camera, i.e., the image acquisition means 20, and uses the digitalized image data to process temporal and spatial information of the subject 5 such as the size, trajectory, speed and location.

The image processing unit 50 may be composed of software and hardware such as a frame grabber or a computer, and may use an ultrahigh-speed processing scheme through a real-time OS (operating system) which is conventionally represented via a board dedicated to high speed image processing.

Further, the image processing unit 50 may be provided in variable forms in which the acquired image regarding the at least one subject 5 is processed and the information on the size, speed, trajectory, state of the subject 5 is on-boarded to the image acquisition means 20 via the dedicated board to which the real-time OS is mounted.

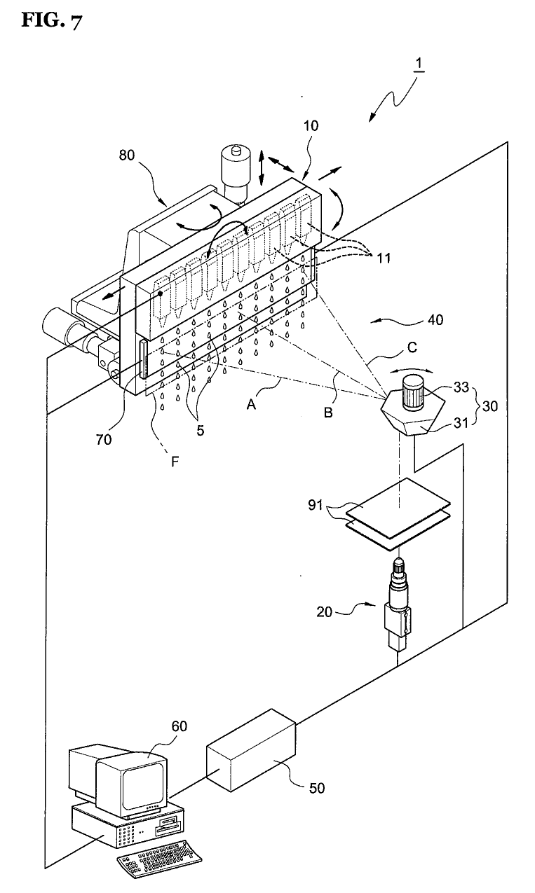

As shown in FIG. 7, in the high speed optical monitoring system 1, it is preferable that an optical filter 91 is arranged on the optical path formed between the subject 5 and the image acquisition means 20 to improve optical characteristics for the subject 5, thereby allowing the image acquisition means 20 to acquire a desired high-quality image which is clearer and more accurate.

At this time, as the optical filter 91, any one of an infrared blocking filter, a polarization filter, a color filter and a band-pass filter, or a combination thereof may be utilized. Further, the optical filter 91 may be arranged in one of the optical path range between the subject 5 and the mirror 30 and the optical path range between the mirror 30 and the image acquisition means 20, or the optical filter may be arranged simultaneously on the above optical path ranges

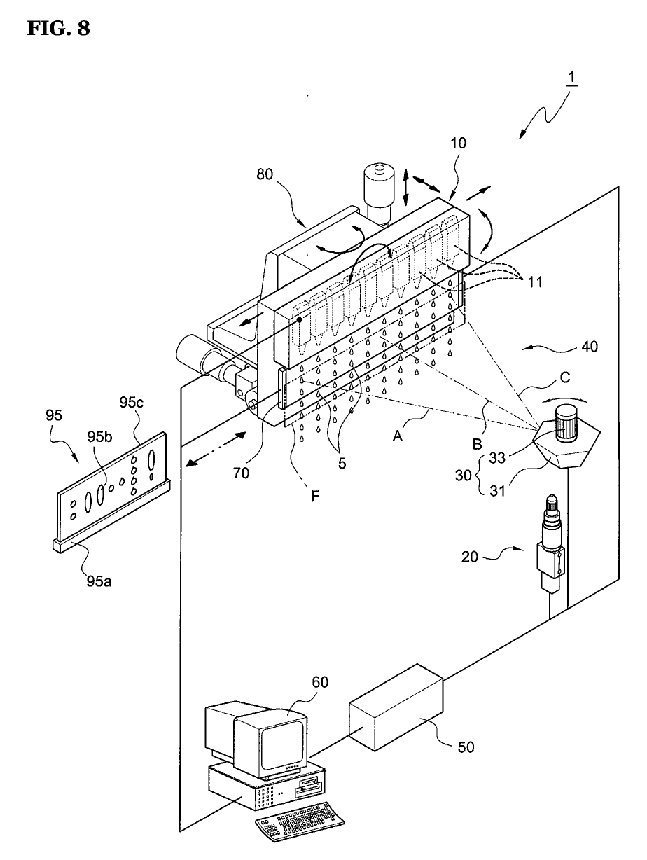

Meanwhile, as shown in FIG. 8, the high speed optical monitoring system 1 according to the present invention may further comprise a reference sample 95 that is arranged on the identical focal space plane F of the subject 5 to check and calibrate the optical alignment relationships among the subject 5, the image acquisition means 20 and the mirror 30 and a scale and a distortion of the obtained image.

At this time, the reference sample 95 may be supported by a reference sample support 95a, and the reference sample support 95a may be provided attachably/detachably on the identical focal space plane F of the subject 5. Further, the reference sample support 95a to which the reference sample 95 is supported may be provided manually or automatically on the identical focal space plane F of the subject 5.

Preferably, the reference sample 95 comprises a substrate 95c made of a transparent, translucent or opaque material. The substrate 65c has patterns 95b formed thereon and corresponding to the subject 5. The patterns 95b of the reference sample 95 are acquired as an image by the image acquisition means 20, it is possible to check and calibrate the optical alignment relationships among the subject 5, the image acquisition means 20 and the mirror 30 through a correlation between the acquired image and the actually-known size of the pattern 95b of the reference sample 95.

Further, the pattern 95b of the reference sample 95 may be used to check and revise the performance of the image processing unit 50.

Meanwhile, the control unit 60 controls the driving of the image acquisition means 20, the mirror 30 and the lighting means 70 to optimize imaging conditions such as a focusing location and a lighting state, thereby allowing the subject 5 to be imaged by the image acquisition means 20.

To this end, each of the image acquisition means 20, the mirror 30 and the lighting means 70 may comprise a driving control module 98 such as a sensor provided therein for transmitting a driving state of the respective element to the control unit 60. The control unit 60 receives and processes a signal transmitted from the respective control module 98, and can feedback-control a driving of the image acquisition means 20, a driving angle of the mirror 30 and the light quantity of the lighting means 70, and the like to an optimized state on the basis of processing results.

Here, among the driving control modules 98, a mirror control module for transmitting the driving state of the mirror 30 to the control unit 60 may be provided. As described above, the mirror control module may be a module provided in the mirror driving unit 33 in itself to transmit an electrical detection signal for the rotational angle of the mirror body 31 to the control unit 60.

Alternatively, although not shown in the drawings, the mirror control module may consist of a beam radiating unit for radiating light onto the mirror body 31 and a mirror-reflected light detection sensor for sensing the light reflected on the mirror body 31 and transmitting a sensed value to the control unit 60. The control unit 60 can drive the mirror driving unit 33 on the basis of the sensed value detected by the mirror-reflected light detection sensor to control the rotational angle of the mirror body 31.

The signal transmitted from the mirror control module allows the control unit 60 to control the rotational angle of the mirror body 31 into the optimal state.

Further, the driving control module 98 may be provided with a lighting control module for transmitting the driving state of the lighting means 70 to the control unit 60. As this lighting control module, a module as an optical sensor capable of measuring a quantity of the light emitted from the lighting means 70 and transmitting a signal on the measured quantity of light to the control unit 60 may be used. Due to the lighting control module, the control unit 60 can adjust a quantity of light emitted from the lighting means 70.

At this time, the control unit 60 may correct an image that has been distorted due to the quantity of light and a light quantity variation for an image acquired by the image acquisition means 20. As described above, it will be apparent that, after the control unit 60 detects and measures the quantity of light and the light quantity variation of the lighting means 70 by using an optical sensor, the control unit can adjust the quantity of light of the lighting means 70 and correct the distorted image caused by the light quantity variation.

Based on the temporal and spatial information such as the size, trajectory, speed, location and the like of the subject 5, which were obtained by a processing of the image processing unit 50, the control unit 60 can feedback-control a generation of the subject 5 in the subject source 11 to control the temporal and spatial physical quantities such as the size, trajectory, speed and location of the subject 5 as well as the quantity of light, impulse time, impulse timing and the like of the lighting means 70. To this end, the subject source 11 may include a subject generation controller 15 provided therein.

Below, the method of monitoring a plurality of subjects 5 by using the high speed optical monitoring system 1 according to the present invention constructed as above will be described.

The subjects 5 generated from the subject sources 11 are periodically moved by a predetermined distance on the identical focal space plane F. Here, the movement of the subjects 5 may mean that the subjects are discharged from the subject sources 11 and then dropped or discharged onto a predetermined plane.

At this time, in a state where the location of the image acquisition means 20 is aligned, the image acquisition means 20 is focused precisely onto a region of the identical focal space plane F of the subjects 5 arranged in a line along an optical path A formed through the rotational angle adjustment operation for the mirror 30 caused by a control of the control unit 60, and then images precisely the subjects 5 that are moved in the corresponding region.

Then, in a state where the locations of the image acquisition means 20 and the subject source are aligned with respect to each other, a rotational angle of the mirror 30 is adjusted by a control of the control unit 60. Due to a rotation of the mirror, a focal length is changed according to the optical path A between the right source and the mirror, the optical path B between the central source and the mirror and the optical path C between the left source and the mirror. The focal length changed by the rotational angle of the mirror enables an electrically-powered zoom lens to be focused onto the subjects 5, that are moved in the corresponding regions, and to image rapidly and precisely the subjects 5.

While the rotational angle of the mirror 30 is adjusted, the subjects 5 can be imaged quickly and precisely by the image acquisition means 20 using the electrically-powered zoom lens at a location at which the image acquisition means 20 and the subject source 11 are aligned.

Meanwhile, the images of the subjects 5 obtained by the image acquisition means 20 are processed into digitalized image data by the image processing unit 50, so that it is possible to confirm the temporal and spatial information such as the sizes, trajectories, speeds and locations of the subjects 5.

On the basis of the digitalized temporal and spatial information on the subjects 5, the control unit 60 feedback-controls the subject source 11 by means of the subject generation controller 15, so that the temporal and spatial physical quantities such as the sizes, trajectories, speeds and locations of the subjects 5 can be uniformly created. Further, the control unit 60 can control the quantity of light, impulse time and impulse timing of the lighting means 70.

As described above, the high speed optical monitoring system according to the present invention monitors the subjects by using the optical path change operation for the mirror caused by a rotation of the mirror in a state where the subjects and the image acquisition means such as the camera provided with the electrically-powered zoom lens are in stationary state, so that the subjects can be monitored and imaged precisely and at high speed. Consequently, the subject source can be controlled on the basis of the images to adjust actively a generation of the subjects in the subject source.

In the high speed optical monitoring system according to the present invention, the image acquisition means is disposed at a side of the optical path between the subject source and the mirror so that the optical path is changed rapidly by the mirror which is rotating, and a focal length can be corrected through the zoom lens to monitor the subject at a high speed.

In addition, in the high speed optical monitoring system according to the present invention, the image acquisition means is arranged at a front of the subject source and the mirror has an upward/downward inclined mirror surface directed to the subject and the image acquisition means or the optical path is changed through two or more mirrors, and the image acquisition means is arranged at a rear of the subject source, and so a horizontal size of the apparatus can be reduced. In addition, the image acquisition means can be disposed in a vertical region or a rear region corresponding to the subject source support so that the small-sized system can be achieved.

In particular, the subject monitoring system according to the present invention as described above can monitor clearly the subject at a high speed and have a small size. Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed:

1. A high speed optical monitoring system for monitoring at least one subject which is in a stationary state or being moved, comprising:
at least one subject source for generating the subject;
a subject source support for aligning and supporting the subject source so as to allow the subject to be placed on an identical focal space plane;
an image acquisition means provided with an electrically-powered zoom lens capable of controlling a focal length between the image acquisition means and the subject, a magnification and a depth;
a mirror body mounted between the subject and the image acquisition means;
a mirror driving unit for changing a rotational angle of the mirror body;
an image processing unit for processing an image acquired by the image acquisition means into digital data;
a lighting means for illuminating the subject; and
a control unit for controlling the lighting means and driving of the subject source, the image acquisition means and the mirror driving unit.

2. The high speed optical monitoring system as claimed in claim 1, further comprising a subject source alignment unit coupled to the subject source support so as to move linearly the subject source along the X/Y/Z axes and tilt the subject source with respect to each of the X/Y/Z axes.

3. The high speed optical monitoring system as claimed in claim 1, wherein the image acquisition means is a camera having a CCD or CMOS imaging device provided with an electrically-powered device capable of adjusting the magnification, the focal length and the depth.

4. The high speed optical monitoring system as claimed in claim 1, wherein the lighting means utilizes a LED (light emitting diode) or a laser diode.

5. The high speed optical monitoring system as claimed in claim 1, further comprising a light quantity variation compensation unit for compensating light quantity variation of the lighting means.

6. The high speed optical monitoring system as claimed in claim 1, the lighting means comprises a cooling device for blocking heat generated from a light source thereof.

7. The high speed optical monitoring system as claimed in claim 1, further comprises an optical filter provided on the optical path between the subject and the image acquisition means, and the optical filter being at least one of an infrared blocking filter, a polarization filter, a color filter and a band-pass filter.

8. The high speed optical monitoring system as claimed in claim 1, further comprising a reference sample arranged on the identical focal space plane so as to check and calibrate an optical alignment relations among the subject, the image acquisition means and the mirror body and a scale and a distortion of the image acquired.

9. The high speed optical monitoring system as claimed in claim 1, wherein the mirror driving unit transmits an electrical detection signal for the rotational angle of the mirror body to the control unit, and the control unit receives the electrical detection signal for the rotational angle of the mirror body and controls driving of the mirror driving unit so as to control the rotational angle of the mirror body.

10. The high speed optical monitoring system as claimed in claim 1, wherein the image processing unit uses the digital data to process temporal and spatial information including a size, trajectory, speed and location of the subject.

11. The high speed optical monitoring system as claimed in claim 1, wherein the control unit controls a generation of the subject of the subject source, an adjustment of the rotational angle of the mirror body, a driving of an imaging operation of the image acquisition means and a quantity of light, impulse time and impulse timing of the lighting means on a basis of the digital data.

12. The high speed optical monitoring system as claimed in claim 1, wherein the image acquisition means is placed at a side of an optical path between the subject and the mirror body.

13. The high speed optical monitoring system as claimed in claim 1, wherein the mirror body has an inclined mirror surface and the image acquisition means is placed above and below an optical path between the subject and the mirror body.

14. The high speed optical monitoring system as claimed in claim 1, wherein the mirror body has a plurality of inclined mirror surfaces and the image acquisition means is placed at a rear of an optical path between the subject and the mirror body.
